(19) United States
(12) Patent Application Publication
(10) Pub. No.: US 2009/0109291 A1
(43) Pub. Date: Apr. 30, 2009

(54) CONVENIENCE STORE SECURITY SYSTEM

(76) Inventors: Inn-Pyo PARK, Seoul (KR); Young-Hoo PARK, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/972,934

(22) Filed: Jan. 11, 2008

(30) Foreign Application Priority Data
Oct. 24, 2007 (KR) 10-2007-0107232

(51) Int. Cl. H04N 7/18

(52) U.S. Cl. 348/156; 348/E07.001

(57) ABSTRACT

Disclosed herein is a convenience store security system 1 having a safe 10 and an unmanned security device 20. The safe 10 is configured to store money 5 at a convenience store 2, and includes a money slot 11 used to deposit the money 5 without unlocking the safe 10, a timer 12a-equipped locking unit 12 configured to be unlocked after a predetermined time has elapsed when an unlocking operation is performed, and a remote control unit 13 configured to be capable of performing the operation of remotely unlocking the locking unit 12. The unmanned security device 20 installed by an unmanned security company 3 so as to provide an unmanned security service to the convenience store 2, and configured to perform the operation of unlocking the locking unit 12 by remotely controlling the remote control unit 13 in response to a request from the convenience store 2.

### BACKGROUND OF THE INVENTION

1. Field of the Invention

The present invention relates generally to a security system, and, more particularly, to a convenience store security system that is particularly suitable for securing a convenience store, which is vulnerable to crimes such as robbery and theft.

2. Description of the Related Art

Recently, robbery and theft cases frequently occur in convenience stores late at night when there are few people about, so that various crime prevention measures for convenience stores have been explored.

Generally, security (surveillance or guarding) means applied to such convenience stores includes an unmanned security service capable of mobilizing an emergency response team and a Closed Circuit Television (CCTV) device having a function of monitoring and recording people who enter and leave convenience stores.

However, generally, robbery and theft cases that occur in convenience stores have characteristics in that a criminal threatens a sales clerk using a deadly weapon, completes a crime, and then runs away in a short time, that is, in less than one or two minutes. Therefore, the existing unmanned security system, which requires several minutes to mobilize a response team after an emergency call has been made, is of limited use in preventing crimes or in apprehending criminals. Meanwhile, the existing CCTV device is used to apprehend criminals by reading records after crimes have been committed, so that the CCTV device has problems in that it has limited ability to prevent crimes and it is ineffective when criminals commit crimes while covering their faces.

Because of the above-described limitations of the conventional convenience store security systems, there is the need for a security system which is capable of preventing crimes in advance and is helpful in apprehending criminals.

### SUMMARY OF THE INVENTION

Accordingly, the present invention has been made keeping in mind the above problems occurring in the prior art, and an object of the present invention is to provide a new security system capable of solving the problems with the above-described conventional convenience store security systems, the new security system being constructed such that crimes cannot be completed before an unmanned security service has mobilized an emergency response team, so that criminals are fundamentally prevented from targeting a convenience store for crimes, with the result that the crimes targeting a convenience store can be prevented and, even in the case where a crime is committed, a criminal can be apprehended before the crime is completed by mobilizing an emergency response team.

In order to accomplish the above object, the present invention provides a convenience store security system.

The convenience store security system according to the present invention includes a safe and an unmanned security device.

The safe is used to store money at a convenience store, and includes a money slot used to deposit the money without unlocking the safe, a timer-equipped locking unit configured to be unlocked after a predetermined time has elapsed when an unlocking operation is performed, and a remote control unit configured to be capable of performing an operation of remotely unlocking the locking unit.

The unmanned security device is installed by an unmanned security company so as to provide an unmanned security service to the convenience store, and configured to perform an operation of unlocking the locking unit by remotely controlling the remote control unit in response to a request from the convenience store.

Preferably, the convenience store security system according to the present invention further includes a recognition device for determining whether a request for the unmanned security company to unlock the locking unit from the convenience store is valid.

Preferably, the recognition device is a Closed Circuit Television (CCTV) device installed in the convenience store; and images captured by the CCTV device are transmitted to the unmanned security device in real time such that the unmanned security company can monitor them in real time.

Preferably, the convenience store security system according to the present invention further includes criminal immobilization means which is installed in the convenience store, and can be operated by the unmanned security company using the unmanned security device in a remote manner or by the manager of the convenience store, thereby immobilizing criminals.

Preferably, the safe includes a see-through window such that at least some of the stored money can be viewed from an outside.

Preferably, the convenience store security system according to the present invention further includes a mobile unlocking device such that the manager of the convenience store can perform the operation of unlocking the locking unit of the safe.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing a convenience store security system according to the present invention; and

FIG. 2 is a block diagram showing the convenience store security system according to the present invention.

### DESCRIPTION OF THE PREFERRED EMBODIMENTS

Hereinafter, embodiments of a convenience store security system according to the present invention will be described in detail with reference to the attached drawings. Although the preferred embodiments below have been disclosed for purposes of illustrating the convenience store security system according to the present invention, they are not intended to limit the scope of the present invention.

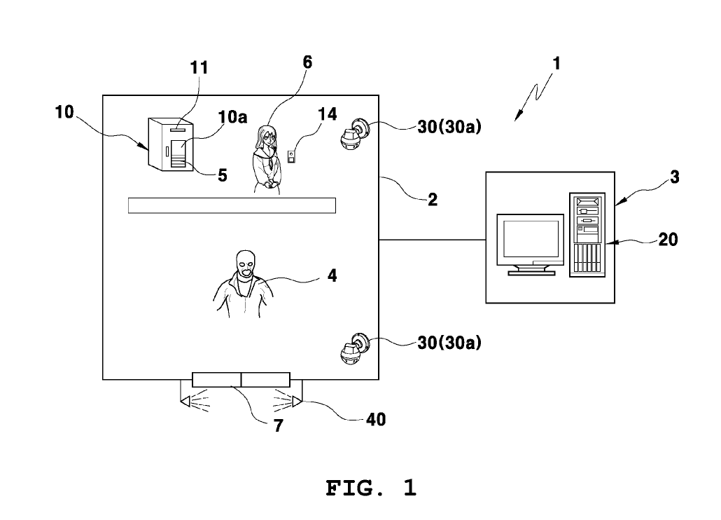

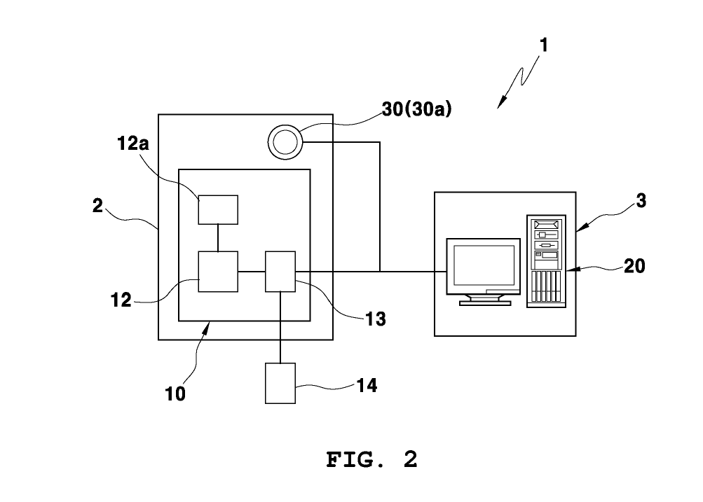

FIG. 1 is a schematic diagram showing a convenience store security system according to the present invention, and FIG. 2 is a block diagram showing the convenience store security system according to the present invention.

Basically, the convenience store security system 1 according to the present invention is a system that widely informs potential criminals that it is fundamentally impossible to rob a convenience store of product sales revenue (money), so that an attempt to commit a crime is fundamentally prevented, with the result that robbery and theft cases in the convenience store are prevented in advance and, should such crimes be attempted, the criminals can be apprehended before the crime is completed.

As shown in FIGS. 1 and 2, the convenience store security system 1 according to the present invention basically includes a safe 10 installed in a convenience store 2, and an unmanned security device 20 installed in an unmanned security company 3.

The safe 10 is a commercial safe for storing the valuables (that is, money which is product sales revenue) of the convenience store 2. However, according to the characteristics of the present invention, the safe 10 includes a money slot 11, a locking unit 12 equipped with a timer 12a, and a remote control unit 13.

The money slot 11 is, for example, a narrow slot-shaped opening which allows money 5 to be deposited in the safe 10 without unlocking the safe 10. The manager 6 (for example, an owner or a sales clerk) of the convenience store 2 stores a minimum amount of money (for example, about $100), which will be used as change, in the Point Of Sales (POS) terminal of a counter, and deposits and stores remaining money in the safe 10 through the money slot 11.

As described above, the main object of the system 1 of the present invention is to cause a criminal 4 fundamentally abandon the attempt to commit a crime rather than to apprehend a criminal 4 who has already committed a crime, thereby preventing crimes from being committed. Therefore, it is preferable that the safe 10 be provided with a see-through window 10a which is not easily damaged by external force, thereby widely informing that only a small amount of money can be acquired by robbery and theft because almost all of the money 5 in the convenience store 2 is stored in the safe 10. As long as the see-through window 10a can show the money 5 deposited in the safe 10, the size and location of the see-through window 10a are not limited. For the same reason, it is preferable that the safe 10, which is applied to the present invention, be provided in a location that is clearly visible to people who enter and leave the convenience store 2.

The locking unit 12 is the device for locking and unlocking the commercial safe 10. According to the characteristics of the present invention, the locking unit 12 is equipped with the timer 12a, so that when the operation of unlocking the locking unit 12 is performed in order to unlock the safe 10, the locking unit 12 is not instantly unlocked, but is unlocked after a predetermined time (for example, five minutes), set by the timer 12a, has elapsed.

As described above, the locking unit 12 is equipped with the timer 12a so that the locking unit 12 can be unlocked only after a predetermined time has elapsed. The reason for this is so that the safe 10 can be unlocked only after a predetermined time has elapsed even if a criminal 4 threatens the manager 6 of the convenience store and tries to unlock the safe 10, thereby buying time such that the emergency response team of guards or police officers can be mobilized during the waiting period before the safe is unlocked. If the above-described fact is widely known to potential criminals, the potential criminals may be led to abandon the attempt to commit the crime, thereby helpfully preventing crimes from being committed.

The time set in the timer 12a may be determined differently depending on the security conditions for the corresponding convenience store 2 (the distance between the convenience store and an unmanned security company or a police office and the frequency with which customers enter and leave). It is preferable that the time set in the timer 12a be a time (for example, five minutes) within which the emergency response team of guards or police officers can be mobilized.

Further, it is preferable that the convenience store 2, based on the head office thereof, make it known that the safe 10 cannot be instantly unlocked and also that almost all money 5 is stored in the safe 10. Further, it is preferable that a notice announcing the above-described facts be posted in the convenience store, thereby preventing crimes from being committed.

The remote control unit 13 is not a device for allowing the manager of the convenience store to perform operation of unlocking the locking unit 12, but is a device for allowing the unmanned security company 3 to remotely perform operation of unlocking the locking unit 12. Since the remote control unit 13 is mounted in the safe 10, the unmanned security company 3 remotely performs control on the remote control unit 13 in response to a request from the manager 6 of the convenience store 2 such that the locking unit 12 is unlocked. Therefore, the locking unit 12 is unlocked after the time set in the timer 12a has elapsed.

Since the detailed configurations of the safe 10, the locking unit 12 equipped with the timer 12a, and the remote control unit 13 can be easily constructed so as to be suitable for the purpose of the present invention by applying the general electrical and electronics technologies of corresponding technical fields, a detailed description thereof is omitted.

The unmanned security device 20 is a device configured such that the unmanned security company 3 with which the convenience store 2 is affiliated provides an unmanned security service to the convenience store 2.

Compared to a conventional unmanned security device, the characteristics of the unmanned security device 20 of the system 1 of the present invention are that the unmanned security company 3 remotely controls the remote control unit 13, installed in the safe 10 of the convenience store 2, via a wired/wireless connection, so that the safe 10 can be remotely unlocked.

In addition to the characteristic configuration of the unmanned security device 20 applied to the system 1 of the present invention, it is apparent that various types of devices (sensors and gate locking units), provided from the unmanned security company 3 so as to provide a general unmanned security service, can be included in the unmanned security device 20.

In the above-described convenience store security system 1 of the present invention, almost all money is stored in the safe 10, the unlocking of the safe 10 is controlled not by the convenience store 2 but by the unmanned security company 3, and the unlocking operation of the safe 10 is performed after a predetermined time has elapsed after unlocking manipulation has been performed. Therefore, it is actually impossible to threaten the manager 6 of the convenience store 2 and steal the money 5 in the safe 10 before an emergency response team is mobilized. Nevertheless, if a crime is committed, the manager 6 of the convenience store 2 informs the unmanned security company 3 of an emergency situation using an emergency call (for example, an emergency bell (not shown)), which is included in the unmanned security device 20 and is part of an unmanned security service provided by the unmanned security company 3, and thus the emergency response team of guards or police officers is mobilized before the crime is completed, a criminal is apprehended, or a criminal is made to run away without completing the crime.

Meanwhile, an exceptional case, in which, for example, the particular manager of the convenience store 2 (for example, an owner who occasionally drops by the convenience store to collect money) may want to directly unlock the safe 10 without being controlled by the unmanned security device 20 of the unmanned security company 3 so as to avoid a hassle, may occur depending on the situation. For this purpose, the system 1 of the present invention may include a mobile unlocking device 14 with which the particular manager can directly unlock the locking unit 12 of the safe 10 without being controlled by the unmanned security device 20.

Other than the characteristic configuration of the present invention, for the detailed configuration of the unmanned security device 20 and the remote control of the remote control unit 13 using the unmanned security device 20, remote control technology using wired/wireless communication, which is widely generalized in the corresponding technical field, can be applied to be suitable for the present invention, so that a detailed description thereof is omitted.

In order for the system 1 of the present invention to completely accomplish the object thereof, it is preferable that the unmanned security company 3 be able to determine whether the convenience store 2 validly requests the unmanned security company 3 to unlock the locking unit 12. For this purpose, the system 1 of the present invention may include a recognition device 30 which can determine whether the request to unlock the locking unit 12 is valid.

For the recognition device 30, as long as the unmanned security company 3 can determine whether the request to unlock the locking unit 12 is valid, the recognition device 30 is not particularly limited. Preferably, the CCTV device 30a, installed in the convenience store 2, may be applied.

The CCTV device 30a is a device which is commercially installed for the security of the convenience store 2. The CCTV device 30a, applied to the present invention, is connected to the unmanned security device 20 and is configured to transmit captured images to the unmanned security device 20 in real time via wired/wireless communication.

The unmanned security company 3 views images transmitted from the CCTV device 30a using the unmanned security device 20, checks whether a person, who is viewed on a screen and requests that the safe be unlocked, is identified as the manager 6 (an owner or a sales clerk) who is validly registered at the convenience store 2, and remotely unlocks the locking unit 12 in the case where the registered manager 6 is identified. Otherwise, a measure of mobilizing an emergency response team is taken while a measure of unlocking a safe is not taken.

In addition to the CCTV device 30a, various types of means for identifying a proper manager, such as a password or fingerprint recognition, which are input when a safe is requested to be unlocked, can be applied to the present invention as the recognition device 30.

In order to be prepared for the emergency case in which a criminal runs away after completing a crime when the mobilization of an emergency response team is not realized by the time the crime is completed, or in which the criminal runs away without completing the crime, the system 1 of the present invention may further include criminal immobilization means 40 which can immobilize the criminal 4 who runs away.

The criminal immobilization means 40, such as a gas spray device, is a commercial unit capable of neutralizing a criminal when applied to a criminal. For example, at the moment at which the criminal 4 opens and goes out the door 7 of the convenience store 2, the staff of the unmanned security company 3, who monitors the action of the criminal 4 through the CCTV device 30a, remotely operates a switch using the unmanned security device 20 or the manager 6 of the convenience store 2 operates the switch, so that the criminal immobilization means 40 (for example, a gas spray device) installed on the upper portion of the door 7 is operated and tear gas is sprayed on the criminal 4, thereby preventing the criminal from running away.

Although the convenience store has been described as an object to which the system of the present invention is applied, it is apparent that the present invention can be applied to other facilities which have security problems similar to those of a convenience store.

According to the convenience store security system, if the fact that the money in a convenience store is stored in a safe which cannot be manipulated to be unlocked and the fact that, even if an attempt is made to unlock the safe, the safe is not instantly unlocked but is unlocked after a time interval sufficient for the guards of an unmanned security company or police officers to mobilize an emergency respond team, are widely known, criminals are aware that a crime cannot actually be completed within a short time, and thus abandon an attempt to commit a crime, so that an advantage is conferred in that crimes in convenience stores can be considerably prevented. Nevertheless, in the case in which a crime is committed, due to a timer, the guards of an unmanned security company or police officers can mobilize an emergency response team within the time (for example, five minutes) that it takes to unlock the safe, so that an advantage is conferred in that the possibility of a criminal running away before the crime is completed or of a criminal being apprehended can be considerably increased.

Further, in the convenience store security system according to the present invention, an unmanned security company or the manager of a convenience store can immobilize a criminal who runs away by operating criminal immobilization means, so that an advantage is conferred in that the probability that a criminal can be apprehended is increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A convenience store security system, comprising:
a safe 10 configured to store money 5 at a convenience store 2, and include a money slot 11 used to deposit the money without unlocking the safe 10, a timer 12a-equipped locking unit 12 configured to be unlocked after a predetermined time has elapsed when an unlocking operation is performed, and a remote control unit 13 configured to be capable of performing an operation of remotely unlocking the locking unit 12; and
an unmanned security device 20 installed by an unmanned security company 3 so as to provide an unmanned security service to the convenience store 2, and configured to perform an operation of unlocking the locking unit 12 by remotely controlling the remote control unit 13 in response to a request from the convenience store 2.

2. The convenience store security system as set forth in claim 1, further comprising a recognition device 30 for determining whether a request for the unmanned security company 3 to unlock the locking unit 12 from the convenience store 2 is valid.

3. The convenience store security system as set forth in claim 2, wherein:
the recognition device 30 is a Closed Circuit Television (CCTV) device 30a installed in the convenience store 2; and
images captured by the CCTV device 30a are transmitted to the unmanned security device 20 in real time such that the unmanned security company 3 can monitor them in real time.

4. The convenience store security system as set forth in claim 1, further comprising criminal immobilization means 40 which is installed in the convenience store 2, and can be operated by the unmanned security company 3 using the unmanned security device 20 in a remote manner or by a manager 6 of the convenience store 2, thereby immobilizing criminals 4.

5. The convenience store security system as set forth in claim 1, wherein the safe 10 includes a see-through window 10a such that at least some of the stored money 5 can be viewed from an outside.

6. The convenience store security system as set forth in claim 1, further comprising a mobile unlocking device 14 such that a manager 6 of the convenience store 2 can perform an operation of unlocking the locking unit 12 of the safe 10.
